(19) United States
(12) Patent Application Publication
(10) Pub. No.: US 2018/0176549 A1
(43) Pub. Date: Jun. 21, 2018

(54) MULTI-VIEW-ANGLE IMAGE CAPTURING DEVICE AND MULTI-VIEW-ANGLE IMAGE INSPECTION APPARATUS USING THE SAME

(71) Applicant: UTECHZONE CO., LTD., New Taipei City (TW)

(72) Inventors: Hsun-Hao CHANG, New Taipei City (TW); Yen-Song CHEN, New Taipei City (TW)

(21) Appl. No.: 15/840,626

(22) Filed: Dec. 13, 2017

(30) Foreign Application Priority Data
Dec. 16, 2016 (TW) 105141833

(51) Int. Cl. G06T 5/50; G06T 7/00

(52) U.S. Cl. CPC H04N 13/0447; G06T 7/0002; G06T 5/50

(57) ABSTRACT

A multi-view-angle image capturing device for capturing surface images of a object comprising a pickup device, an image augmentation module, an image capturing device, and an inspection device. The pickup device loads the object to an inspection position. The image augmentation module is configured around the inspection position so as to reflect different view angle images of the object. The image capturing device is positioned at the inspection position and captures images of the object and images reflected by the image augmentation module so as to obtain a plurality of view angle images of the object. The inspection device receives the plurality of the view angle images of the object so as to inspect surface of the object.

### BACKGROUND OF THE INVENTION

### 1. Technical Field

The present invention relates to a multi-view-angle image capturing device and a multi-view-angle image inspection apparatus thereof more particularly to a multi-view-angle image capturing device and a multi-view-angle image inspection apparatus thereof for obtaining a plurality of view angle images of objects in a single shot.

### 2. Description of the Prior Art

Automated Optical Inspection (AOI) is an inspection technique using mechanical vision to improve the error of the traditional inspection technique that uses manpower to operate the optical instrument. The application filed of AOI includes research development of high-tech industry, manufacturing quality control, national defense, daily commodities, health care, environmental protection, electricity and others.

Image processing technology is applied to newspaper industry in early years and gradually applied to other filed lately. At present, the mechanical vision has been widely used in the production line, which is mainly for, during the products transporting to the detection station via the transfer device, the image capturing device captures the images of objects and identifies their features, and then the sorting device determines the objects that has deficiency.

As is well known in the art, it is difficult to process an image of a curved-surface object under inspection, the main reason being that when an inspection apparatus takes an image of a curved-surface object, the curved surface tends to result in data compression along the edge of the object. Even when images are taken from two sides of the object by one or two cameras, the compressed image portions along the edge of the object cause problems in image inspection. As a solution, it is common practice to take a plurality of images of a curved-surface object under inspection from multiple view angles either simultaneously via a plurality of cameras, or by rotating the object with a rotation mechanism and taking the images sequentially. In either case, the objective is to detect the object's surface from different view angles. However, using a plurality of cameras incurs high equipment cost, and rotating the object prolongs inspection time and lowers the efficiency of the inspection process.

### BRIEF SUMMARY OF THE INVENTION

The aim of the present invention is to address the issue of the conventional inspection of surface image of sphere object having problems of high equipment cost and insufficient detection efficiency.

To solve the aforesaid drawbacks, the present invention provides a multi-view-angle image capturing device for capturing the images of object surface. The multi-view-angle image capturing device includes a pickup device, an image augmentation module, and an image capturing device. The pickup device loads the object to an inspection position. The image augmentation module is configured around the inspection position so as to reflect different view angle images of the object. The image capturing device is positioned at the inspection position and captures images of the object and images reflected by the image augmentation module so as to obtain a plurality of view angle images of the object.

Another objective of the present invention is to provide a multi-view-angle image inspection apparatus for inspecting the image of object surface. The multi-view-angle image inspection apparatus includes a pickup device, an image augmentation module, an image capturing device, and an inspection device. The pickup device loads the object to an inspection position. The image augmentation module is configured around the inspection position so as to reflect different view angle images of the object. The image capturing device is positioned at the inspection position and captures images of the object and images reflected by the image augmentation module so as to obtain a plurality of view angle images of the object. The inspection device receives the plurality of view angle images of the object so as to inspect surface of the object.

Another object of the present invention is to provide a multi-view-angle image inspection apparatus for inspecting surface of an object. The multi-view-angle image inspection apparatus includes a first multi-view-angle image capturing device having a first pickup device, a first image augmentation module and a first image capturing device; a second multi-view-angle image capturing device having a second pickup device, a second image augmentation module and a second image capturing device and an inspection device. The first pickup device secures the object at a first inspection position and wherein the first image augmentation module reflects different view angle images of the object so that the first image capturing device captures upper half images of the object. The second pickup device secures the object at a second inspection position and wherein the second image augmentation module reflects different view angle images of the object so that the second image capturing device captures lower half images of the object. The inspection device receives the upper half images and the lower half images of the object for inspecting surface of the object.

### BRIEF DESCRIPTION OF THE DRAWINGS

FIG. 1 is a block diagram of the multi-view-angle image inspection apparatus of the present invention;

FIG. 2 is a schematic view (1) of a block distribution of the object;

FIG. 3 is a schematic view (2) of a block distribution of the object;

FIG. 4 is a side view (1) of an image augmentation module according to the first embodiment of the present invention;

FIG. 5 is a top view (1) of an image augmentation module according to the first embodiment of the present invention;

FIG. 6 is a side view (2) of an image augmentation module according to the first embodiment of the present invention;

FIG. 7 is a bottom view (2) of an image augmentation module according to the first embodiment of the present invention;

FIG. 8 is a side view (1) of an image augmentation module according to the second embodiment of the present invention;

FIG. 9 is a top view (1) of an image augmentation module according to the second embodiment of the present invention;

FIG. 10 is a side view (2) of an image augmentation module according to the second embodiment of the present invention;

FIG. 11 is a bottom view (2) of an image augmentation module according to the second embodiment of the present invention;

FIG. 12 is a side view (1) of an image augmentation module according to the third embodiment of the present invention;

FIG. 13 is a top view (1) of an image augmentation module according to the third embodiment of the present invention;

FIG. 14 is a side view (2) of an image augmentation module according to the third embodiment of the present invention; and

FIG. 15 is a bottom view (2) of an image augmentation module according to the third embodiment of the present invention;

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

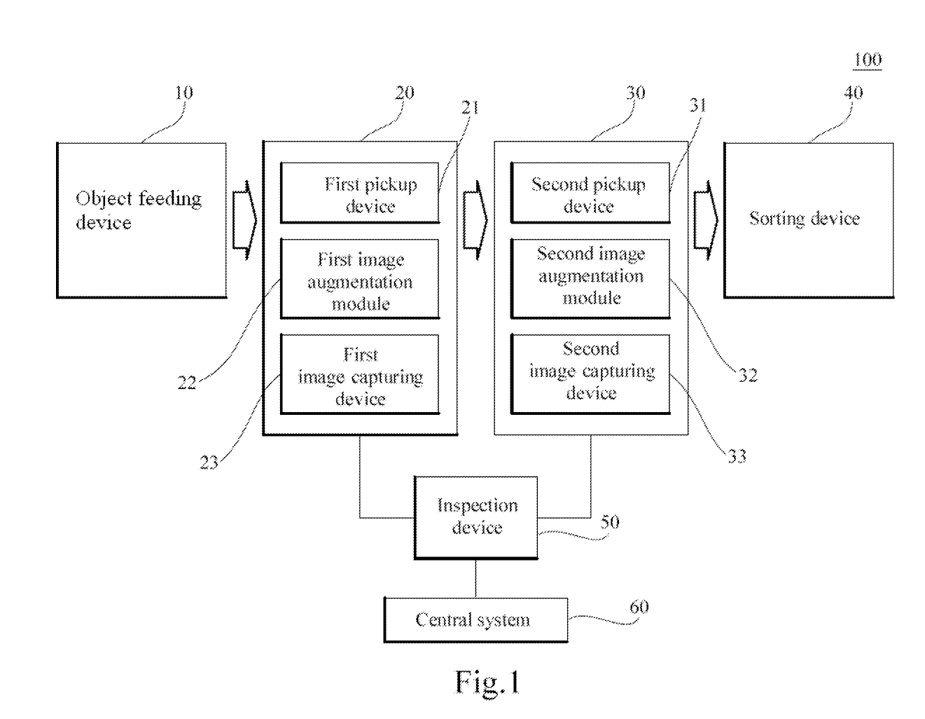

Please refer to FIG. 1 for a block diagram of the multi-view-angle image inspection apparatus of the present invention.

In this embodiment, the multi-view-angle image inspection apparatus 100 is configured to inspect the surface of a object SP and includes a object feeding device 10, a first multi-view-angle image capturing device 20, a second multi-view-angle image capturing device 30, a sorting device 40, and an inspection device 50.

The object feeding device 10 is configured to supply the object SP in order to carry out inspection. More specifically, the object feeding device 10 may be a conveyor belt, a feeding rail, a loading device, or any other similar device capable of supplying the object SP; the present invention has no limitation in this respect.

The first multi-view-angle image capturing device 20 includes a first pickup device 21, a first image augmentation module 22 and a first image capturing device 23. The first pickup device 21 secures the SP at a first inspection position and the first image augmentation module 22 reflects different view angle images of the object SP so that the first image capturing device 23 captures upper half images of the object SP. More specifically, the first multi-view-angle image capturing device 20 uses the first pickup device 21 to grasp the object SP from the object feeding device 10 and then move the object SP to the first inspection position, where the upper half of the object SP will be photographed. The first image augmentation module 22 is configured around the first inspection position so as to reflect different view angle images of the object SP for the first image capturing device 23, which is provided on one side of the object SP, to obtain a plurality of images of the object SP simultaneously, thereby increasing inspection efficiency.

The second multi-view-angle image capturing device 30 includes a second pickup device 31, a second image augmentation module 32 and a second image capturing device 33. The second pickup device 31 secures the SP at a second inspection position and the second image augmentation module 32 reflects different view angle images of the SP so that the second image capturing device 33 captures lower half images of the object SP. More specifically, the second multi-view-angle image capturing device 30 uses the second pickup device 31 to grasp the object SP from the first multi-view-angle image capturing device 20 and then move the object SP to the second inspection position, where the lower half of the object SP will be photographed. The second image augmentation module 32 is configured around the second inspection position so as to reflect different view angle images of the object SP for the second image capturing device 33, which is provided on one side of the object SP, to obtain a plurality of images of the object SP simultaneously, thereby increasing inspection efficiency.

In a preferred embodiment, the first pickup device 21 and the second pickup device 31 are vacuum suction devices configured to provide a vacuum suction force in order to suck at the curved surface of the object SP.

The sorting device 40 is configured to sort the object SP in to normal ones or defective ones or sort the object SP according to the types of defects so that the object SP can be collected as classified. More specifically, the sorting device 40 may be a conveyor belt, a loading device, a multi-axis platform, a rotary platform, or any other similar device capable of loading and sorting the objects SP; the present invention imposes no limitation in this regard.

The inspection device 50 may be an image processor for receiving the upper half images and the lower half images of the object SP and then inspecting the surface of the object SP by identifying the images (i.e. the upper half images and the lower half images) to finding defects of the SP. More specifically, the inspection device 50 is configured to look for a defective area of the object SP in the images by an image processing process (e.g., image binarization, noise elimination, edge enhancement, or image enhancement) and send the defective area to a central system 60, where the defective area is subjected to defect classification, human visual inspection, or NG product repair.

The foregoing devices can communicate with a controller through wired or wireless signals. The controller, which coordinates the work to be done by the various devices, may be a central processing unit (CPU), a programmable general-purpose or specific-purpose microprocessor, a digital signal processor, a programmable controller, an application-specific integrated circuit (ASIC), a programmable logic device (PLD), any other similar device, or a combination of the above. A storage unit may be also provided for storing software, firmware, or various data.

A detailed description of the image augmentation modules of the present invention (i.e., the first image augmentation module 22 and the second image augmentation module 32) is given below. The image augmentation modules disclosed in the present invention are configured to assist the first image capturing device 23 and the second image capturing device 33 in photographing the entire surface of the object SP, allowing a multi-view-angle image of the to-be-inspected object SP to be obtained in one take. Each image augmentation module has an opening corresponding to one of the inspection positions and is provided around the SP at the inspection position. Once the pickup device corresponding to each image augmentation module moves to the corresponding inspection position, the image augmentation module reflects a multi-view-angle image of the object SP thereof, in order for the corresponding image capturing device to obtain a plurality of images of multiple surface portions of the object SP in one take. While the object SP in a preferred embodiment is a curved-surface object, the foregoing devices and system are equally applicable to detecting the surface of a object of a different (either regular or irregular) shape or structure.

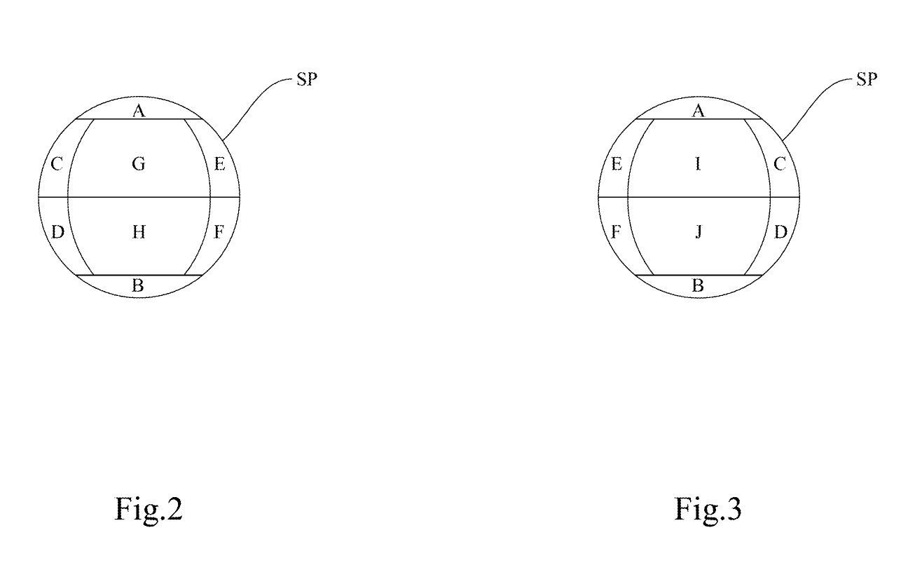

In order to facilitate description of the positions on the object SP in relation to the various light-receiving angles and viewing angles in different embodiments, the object SP is divided into a plurality of areas, as defined below with reference to FIG. 2 and FIG. 3. The object SP is divided into ten sections, namely sections A and B, which are located on two opposite sides of the object SP and correspond to the upper hemisphere and lower hemisphere of the SP respectively, and sections C, D, E, F, G, H, I, and J, which are located between and surround sections A and B. Sections C, G, E, and I adjoin section A while sections D, H, F, and J adjoin section B. If the object SP is viewed as a six-sided object, section A can be regarded as the first side of the object SP, section B as the second side of the object SP, sections C and D as the third side of the object SP, sections E and F as the fourth side of the object SP, sections G and H as the fifth side of the object SP, and sections I and J as the sixth side of the object SP.

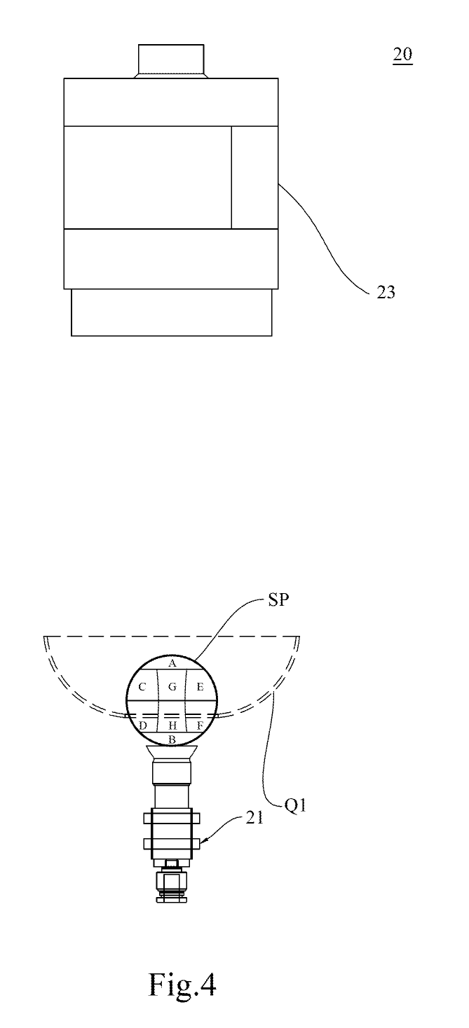

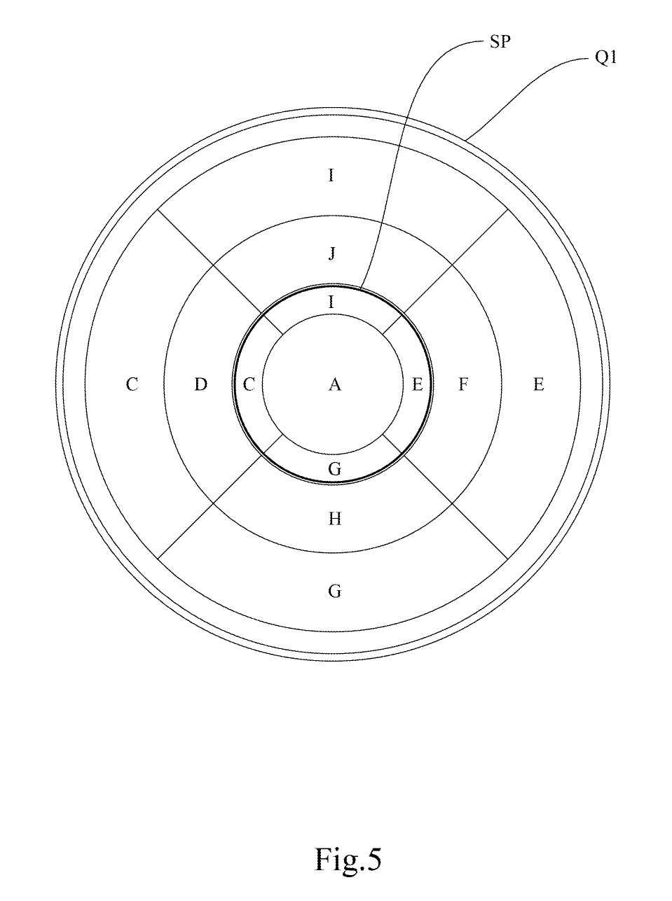

Three different embodiments of the image augmentation modules of the present invention are described below by way of example. Please refer to FIG. 4 to FIG. 7 for various views of the first embodiment to begin with.

In the first embodiment, two image augmentation modules (i.e., the first image augmentation module 22 and the second image augmentation module 32) each configured as a curved-surface mirror are disclosed. Each curved-surface mirror has an opening at the center so that the object SP can be placed in the opening. Moreover, each curved-surface mirror can receive light over a wide range of angles and can therefore reflect most of the portion of the object SP that juts out of the opening.

In a preferred embodiment, the center of the object SP can be moved to the focus of the curved-surface mirror during inspection to increase the reflected area. The inspection procedure corresponding to the first embodiment is detailed below with reference to the multi-view-angle image inspection apparatus and sphere sectioning scheme shown in FIG. 1 to FIG. 3.

Referring to FIG. 4 and FIG. 5, when the first multi-view-angle image capturing device 20 is in inspection operation, the first image capturing device 23 takes an image of the object SP to obtain an image of section A (or the upper hemisphere in general) of the object SP. As the center of the object SP corresponds in position to the focus of the curved-surface mirror Q1, the four peripheral sides of the object SP (including sections C and D, sections E and F, sections G and H, and section I and J) are shown on the curved-surface mirror Q1. That is to say, except for the section grasped by the first pickup device 21 (i.e., section B), all the sections of the SP are included in the image taken, and this is accomplished in one take.

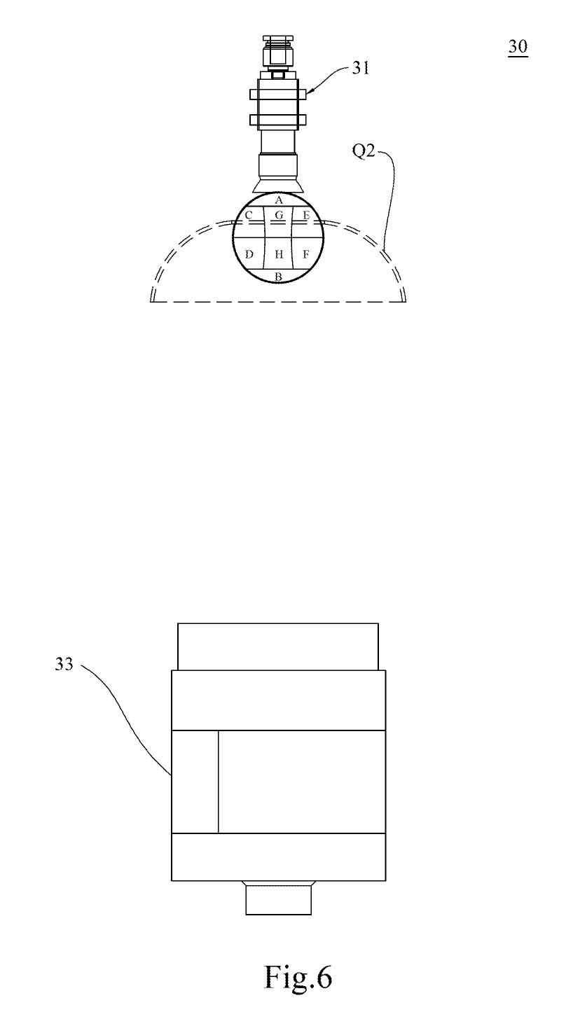

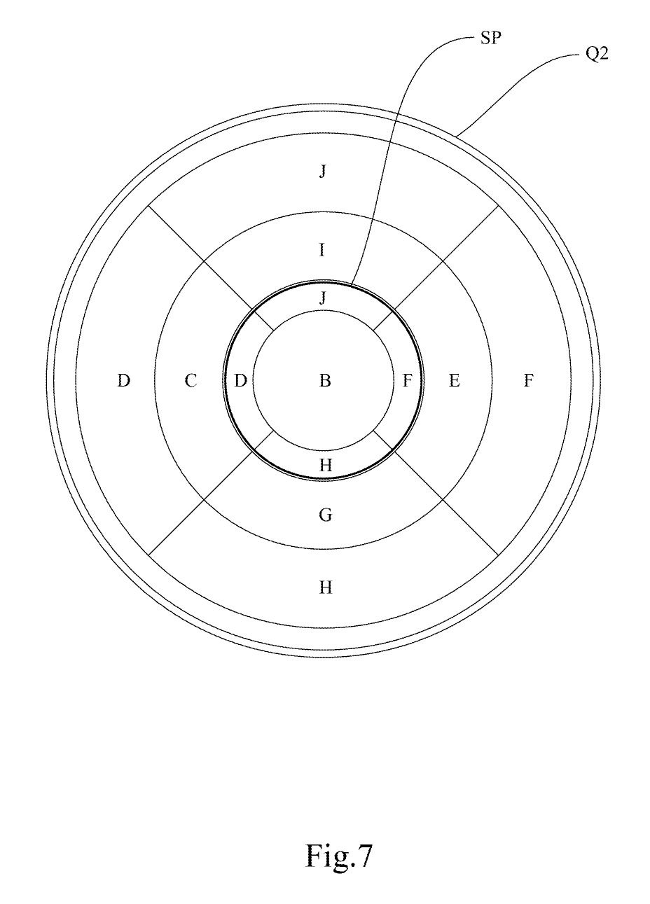

Once photographed by the first multi-view-angle image capturing device 20, the object SP is loaded into the second multi-view-angle image capturing device 30 in order to be photographed on the other side. During the image taking process, referring to FIG. 6 and FIG. 7, the second pickup device 31 grasps section A of the object SP so that section B (or the lower hemisphere in general) of the object SP can be included in the image taken by the second image capturing device 33. Like the first multi-view-angle image capturing device 20, the second multi-view-angle image capturing device 30 also can take an image of the object SP with the assistance of the curved-surface mirror Q2. The resulting image of the object SP, therefore, includes not only section B, but also sections C and D, sections E and F, sections G and H, and sections I and J. By taking this second image in addition to that described in the last paragraph, the object SP is inspected from another angle for defects that cannot be found with the previous image-taking angle. In another preferred embodiment, the second take can dispense with the corresponding image augmentation module because the second image capturing device 33 of the second multi-view-angle image capturing device 30 only has to take an image of section B of the object SP after the first multi-view-angle image capturing device 20 obtains an image of the entire object SP except for section B.

The second preferred embodiment of the image augmentation modules of the present invention (i.e., the first image augmentation module 22 and the second image augmentation module 32) includes two sets of flat mirrors, each set to be configured around the object SP. Each flat mirror is inclined with respect to the object SP and the corresponding image capturing device, wherein an angle is set between the flat mirrors of the image augmentation module and capturing direction of the image capturing device so as to reflect multi-view-angle images of the object SP to the corresponding image capturing device. Inspection with flat mirrors is advantageous in that flat mirrors do not have curvatures and that consequently the reflected images are less likely to deform than those generated by curved-surface mirrors. This allows the image of each part of the object SP to be inspected with reasonable precision.

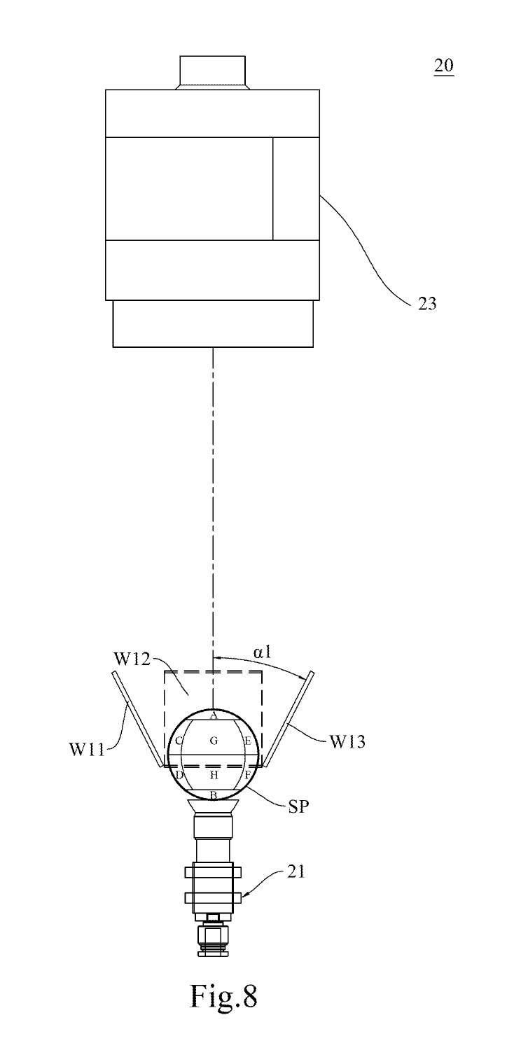

FIG. 8 to FIG. 11 show different views of a set of flat mirrors in the second embodiment of the image augmentation modules of the present invention.

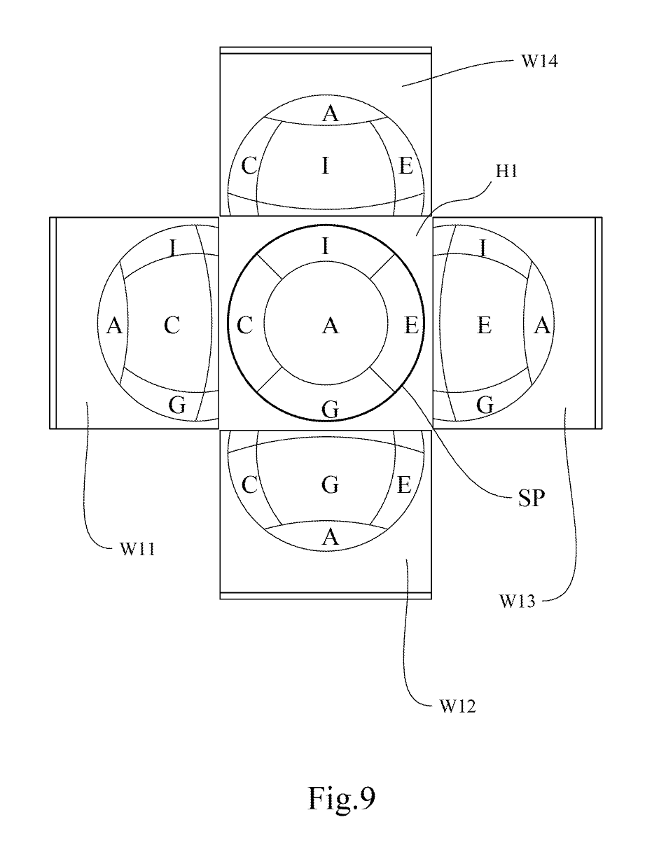

As shown in FIG. 8 and FIG. 9, flat mirrors W11, W12, W13, and W14 of the first multi-view-angle image capturing device 20 are evenly distributed along the periphery of an opening H1 and extend in four directions respectively. The first pickup device 21 places the object SP into the opening H1 in order for the flat mirrors W11, W12, W13, and W14 to reflect the object SP and thereby form images thereof from four angles respectively. As shown in FIG. 8 and FIG. 9, with the flat mirrors W11, W12, W13, and W14 provided in four directions of the object SP respectively, and with section A (or the upper hemisphere in general) of the object SP facing the first image capturing device 23, section C will be reflected by the flat mirror W11, section G by the flat mirror W12, section E by the flat mirror W13, and section I by the flat mirror W14. The five sections of the upper hemisphere of the object SP can therefore be photographed in one take.

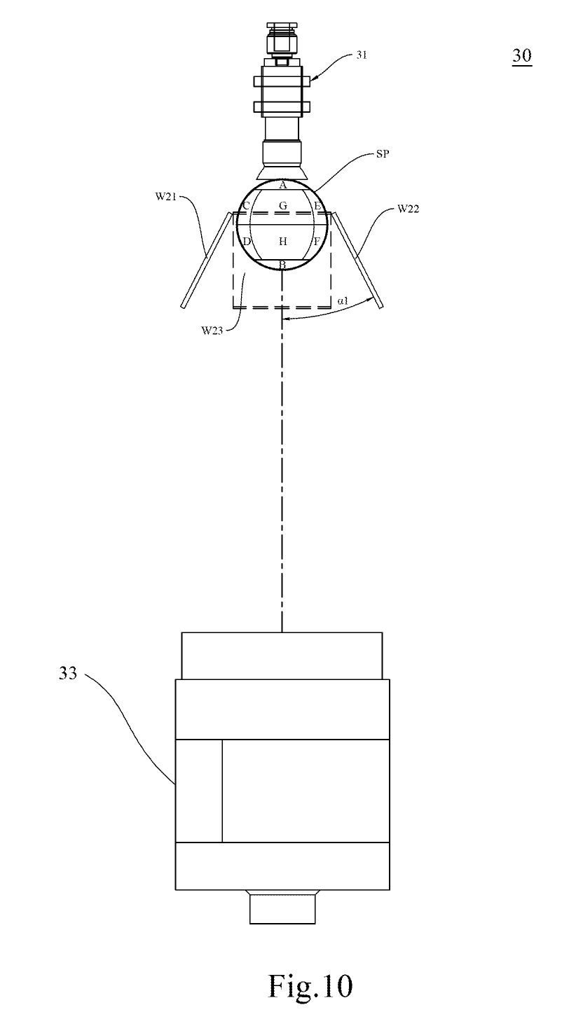

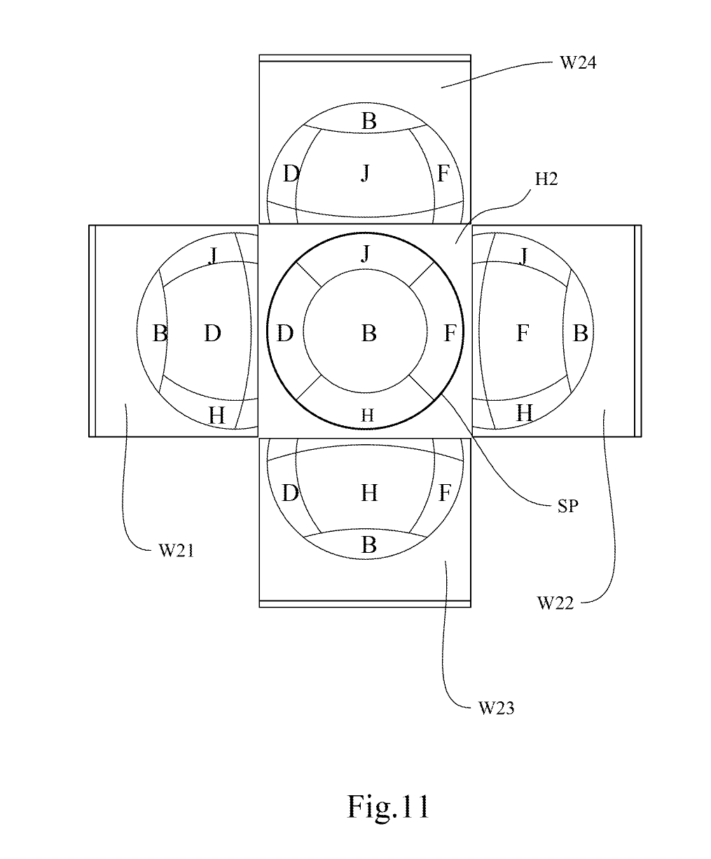

Once photographed by the first multi-view-angle image capturing device 20, the object SP is loaded into the second multi-view-angle image capturing device 30 to have its lower hemisphere photographed. In the second multi-view-angle image capturing device 30, flat mirrors W21, W22, W23, and W24 are evenly distributed along the periphery of an opening H2 and extend in four directions respectively. To photograph the lower hemisphere of the object SP, referring to FIG. 10 and FIG. 11, the second pickup device 31 grasps section A of the object SP so that section B (or the lower hemisphere in general) of the object SP can be photographed. As with the first multi-view-angle image capturing device 20, the second multi-view-angle image capturing device 30 obtains an augmented image of the object SP from the four flat mirrors W21, W22, W23, and W24 and therefore captures not only the image of the object SP itself, but also the augmented image. Thus, in addition to section B, which faces the second image capturing device 33, the image taken of the SP includes section D, as reflected by the flat mirror W21; section F, as reflected by the flat mirror W22; section H, as reflected by the flat mirror W23; and section J, as reflected by the flat mirror W24. With this second take, the part of the object SP that is not photographed in the previous take has its image taken. As a result, images covering the entire object SP are obtained with two takes.

In this embodiment, where four flat mirrors W11-W14 and another four flat mirrors W21-W24 are configured all around the object SP, the point is to obtain the front-side image of the object SP. In order for the focus of each image capturing device to fall on the center of the curved surface to be inspected, the center of the object SP must be moved past the corresponding opening H1 or H2 by an appropriate distance, and the angle al between each flat mirror and the capturing direction of the image capturing device preferably approaches 27 degrees or is within a reasonable range from 17 degrees to 37 degrees, depending on the distance between the flat mirrors W11-W14 or W21-W24 and the object SP and the distance by which the object SP is moved past the corresponding opening.

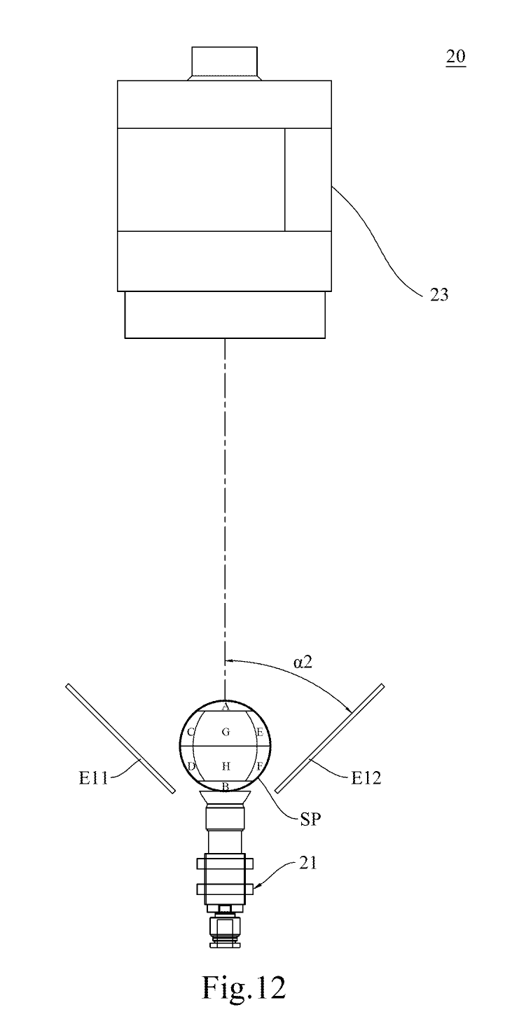

The third embodiment of the image augmentation modules of the present invention is shown in FIG. 12 to FIG. 15.

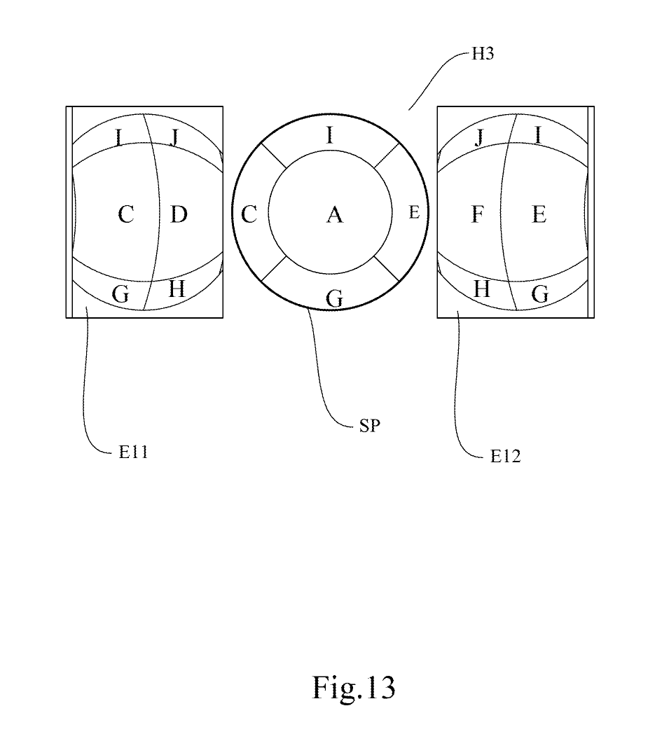

In this embodiment, the image-taking angle of each image capturing device with respect to the object SP is varied by changing the angle of the corresponding flat mirrors E11 and E12, or E21 and E22, with respect to the capturing direction of the image capturing device. As shown in FIG. 12 and FIG. 13, the first pickup device 21 moves the entire object SP through the opening H3 between the flat mirrors E11 and E12 in order for more rear sections of the object SP to be reflected, allowing the front-hemisphere (relatively close to the image capturing device side) and the rear-hemisphere (relatively rear the image capturing device side) of the object SP to be photographed in one take. As each image capturing device can obtain the images of at least two sections of the object SP from one flat mirror, only two flat mirrors are required in this embodiment to obtain the images of five sections. As shown in FIG. 12 and FIG. 13, the image taken by the first image capturing device 23 includes not only section A (or the upper hemisphere in general), but also sections C and D in their entirety, as reflected by the flat mirror E11 provided on one side of the object SP, and sections E and F in their entirety, as reflected by the flat mirror E12 provided on the opposite side of the object SP. Thus, five sections of the object SP are photographed in one take.

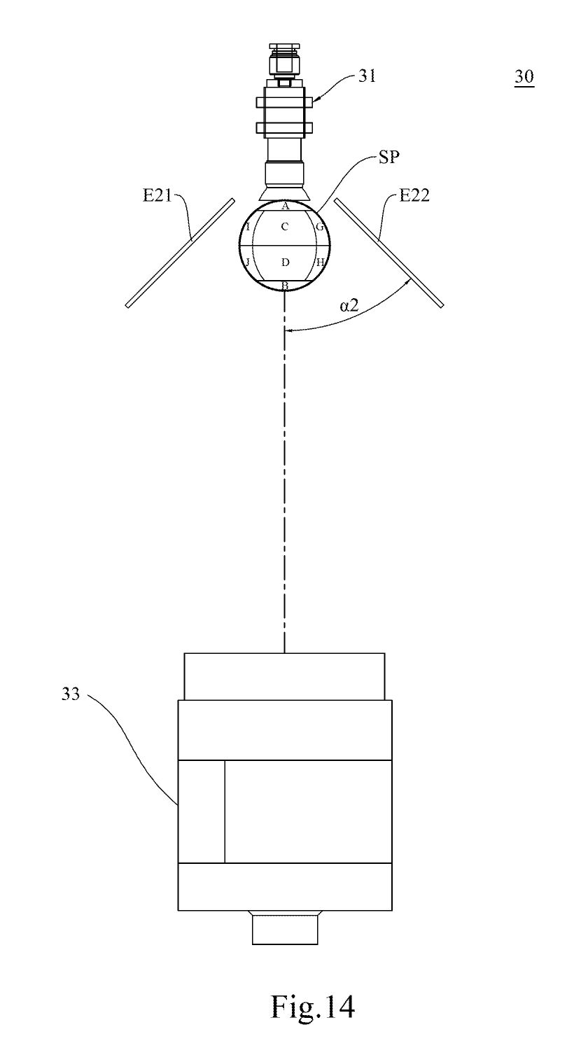

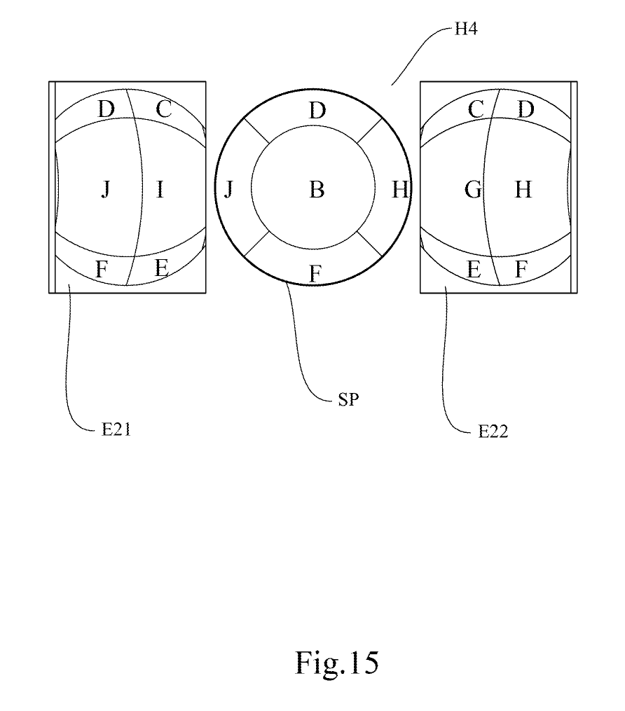

Once photographed by the first multi-view-angle image capturing device 20, the object SP is loaded into the second multi-view-angle image capturing device 30 to have the other side photographed. To photograph the lower hemisphere of the object SP, referring to FIG. 14 and FIG. 15, the second pickup device 31 grasps section A of the object SP so that section B (or the lower hemisphere in general) of the object SP can be photographed. As with the first multi-view-angle image capturing device 20, the second multi-view-angle image capturing device 30 obtains an augmented image of the object SP from the two flat mirrors E21 and E22 and therefore captures not only the image of the object SP itself, but also the augmented image. Thus, in addition to section B, which faces the second image capturing device 33, the image taken of the object SP includes sections I and J in their entirety, as reflected by the flat mirror E21 provided on one side of the object SP, and sections G and H in their entirety, as reflected by the flat mirror E22 provided on the opposite side of the object SP. Consequently, images of all the sections of the object SP are obtained with two takes.

In this embodiment, where two flat mirrors E11 and E12 (or E21 and E22) are provided, the point is to obtain the image of a central portion of the object SP. In order for the focus of each image capturing device to fall on the center of the curved surface to be inspected, the entire object SP must be moved past the corresponding opening, and the angle α2 between each flat mirror E11 or E12 (or each flat mirror E21 or E22) and the capturing direction of the image capturing device preferably approaches 45 degrees or is within a reasonable range from 35 degrees to 55 degrees, depending on the distance between the flat mirrors E11 and E12 (or E21 and E22) and the SP and the distance by which the object SP is moved past the corresponding opening (H3 or H4).

While this embodiment allows the images of five sections of the object SP to be obtained with the assistance of only two flat mirrors E11 and E12 (or E21 and E22), the present invention does not exclude the arrangement of having four flat mirrors at the same time so that certain areas can be inspected repeatedly for higher accuracy.

Apart from providing two or four flat mirrors, it is also feasible to provide only one flat mirror or more than one flat mirror, or only one curved mirror or more than one curved mirrors. All equivalent embodiments that do not depart from the spirit of the present invention should fall within the scope of the invention.

In summary, the present invention allows multiple surface portions of a object (e.g., a sphere) to be photographed in one take, without having to rotate the t object, as is required in the prior art to inspect various sides of the object; thus, the present invention increases the image-taking efficiency considerably. Moreover, now that multiple surface portions of a object can be photographed in one take, there is no need to set up a plurality of cameras for inspecting the object from multiple angles respectively, and the equipment cost incurred is therefore much lower than that in the prior art.

The above is the detailed description of the present invention. However, the above is merely the preferred embodiment of the present invention and cannot be the limitation to the implement scope of the present invention, which means the variation and modification according the present invention may still fall into the scope of the invention.

What is claimed is:

1. A multi-view-angle image capturing device for capturing surface images of an object, including:
a pickup device for loading the object to an inspection position;
an image augmentation module configured around the inspection position so as to reflect different view angle images of the object; and,
an image capturing device, positioned at the inspection position and capturing images of the object and images reflected by the image augmentation module so as to obtain a plurality of view angle images of the object.

2. A multi-view-angle image inspection apparatus for inspecting surface images of an d object, including:
a pickup device for loading the object to an inspection position;
an image augmentation module configured around the inspection position so as to reflect different view angle images of the object;
an image capturing device positioned at the inspection position and capturing images of the object and images reflected by the image augmentation module so as to obtain a plurality of view angle images of the object; and,
an inspection device for receiving the plurality of the view angle images of the object so as to inspect surface of the object.

3. The multi-view-angle image capturing device according to claim 1, wherein the image augmentation module includes a curved-surface mirror and an opening at the center of the curved-surface mirror so that the object can jut out the opening.

4. The multi-view-angle image capturing device according to claim 1, wherein the image augmentation module includes a plurality of flat mirrors configured around the inspection position, wherein an angle is between the flat mirrors and a capturing direction of the image capturing device so that a plurality of view angle images of the object can be reflected.

5. The multi-view-angle image capturing device of claim 4, wherein the flat mirrors are distributed evenly along the periphery in four directions of the inspection position so as to reflect four view angle images of the object at one time.

6. The multi-view-angle image capturing device of claim 5, wherein the angle between the flat mirrors and the capturing direction of the image capturing device ranges from 17 degrees to 37 degrees.

7. The multi-view-angle image capturing device of claim 4, wherein the flat mirrors are configured on two sides of the inspection position so as to reflect two sides view angle images of the object.

8. The multi-view-angle image capturing device of claim 7, wherein the angle between the flat mirrors and the capturing direction of the image capturing device ranges from 35 degrees to 55 degrees.

9. The multi-view-angle image capturing device of claim 1, wherein the pickup device is a vacuum suction device.

10. A multi-view-angle image inspection apparatus for inspecting surface of an object, including:
a first multi-view-angle image capturing device having a first pickup device, a first image augmentation module and a first image capturing device, wherein the first pickup device secures the object at a first inspection position and the first image augmentation module reflects different view angle images of the object, so that the first image capturing device captures upper half images of the object;
a second multi-view-angle image capturing device having a second pickup device, a second image augmentation module and a second image capturing device, wherein the second pickup device secures the object at a second inspection position and the second image augmentation module reflects different view angle images of the object, so that the second image capturing device captures lower half images of the object; and
an inspection device for receiving the upper half images and the lower half images of the object for inspecting surface of the object.

11. The multi-view-angle image inspection apparatus of claim 10, wherein the first image augmentation module and the second image augmentation module are a curved-surface mirror and an opening is at the center of the curved-surface mirror so that the object can jut out the opening.

12. The multi-view-angle image inspection apparatus of claim 10, wherein the first image augmentation module and the second image augmentation module includes a plurality of flat mirrors configured around the first inspection position and the second inspection position, wherein an angle is between the flat mirrors of the first image augmentation nodule and a capturing direction of the first image capturing device, and an angle is between the flat mirrors of the second image augmentation module and a capturing direction of the second image capturing device, so as to reflect the different view angle images of the object.

13. The multi-view-angle image inspection apparatus of claim 12, wherein the flat mirrors are distributed evenly along the periphery in four directions of the first inspection position and second inspection position so as to reflect four view angle images of the object.

14. The multi-view-angle image inspection apparatus of claim 13, wherein the angle between the flat mirrors of the first image augmentation module and the capturing direction of the first image capturing device ranges from 17 degrees to 37 degrees; and
the angle between the flat mirrors of the second image augmentation module and the capturing direction of the second image capturing device ranges from 17 degrees to 37 degrees.

15. The multi-view-angle image inspection apparatus of claim 12, wherein the flat mirrors of the first image augmentation module are configured on two lateral sides of the periphery in four directions of the first inspection position so as to reflect two lateral side view angle images of the object, and the flat mirrors of the second image augmentation module are configured on two other lateral sides of the periphery in four directions of the second inspection position so as to reflect other two lateral side view angle images of the object.

16. The multi-view-angle image inspection apparatus of claim 15, wherein the angle between the flat mirrors of the first image augmentation module and the capturing direction of the first image capturing device ranges from 35 degrees to 55 degrees; and, the angle between the flat mirrors of the second image augmentation module and the capturing direction of the second image capturing device ranges from 35 degrees to 55 degrees.
